(19) United States
(12) Patent Application Publication
(10) Pub. No.: US 2014/0336897 A1
(43) Pub. Date: Nov. 13, 2014

(54) DEVICE AND METHOD FOR OEPRATING A DRIVER ASSISTANCE SYSTEM FOR A VEHICLE

(71) Applicant: Stefan Nordbruch, Kornwestheim (DE)

(72) Inventor: Stefan Nordbruch, Kornwestheim (DE)

(21) Appl. No.: 14/351,831

(22) PCT Filed: Aug. 28, 2012
(86) PCT No.: PCT/EP2012/066631

§ 371 Date: Jul. 29, 2014

(30) Foreign Application Priority Data
Oct. 17, 2011 (DE) 10 2011 084 619.0

(51) Int. Cl. B60W 30/14

(52) U.S. Cl. CPC B60W 30/14
USPC 701/93

(57) ABSTRACT

A device for operating a first driver assistance system for a vehicle includes: a control unit for controlling an operating state of the first driver assistance system, the control unit being designed to control the operating state as a function of an operating state of another driver assistance system for the vehicle.

### BACKGROUND OF THE INVENTION

1. Field of the Invention

The invention relates to a device and a method for operating a driver assistance system for a vehicle, and to a database system as well as a computer program.

2. Description of the Related Art

Driver assistance systems are known as such from published U.S. patent application US 2006/0089765 A1, for example. It describes, for example, an adaptive cruise control (ACC) device. A driver overrides the adaptive cruise control by actuating the accelerator pedal. Subsequently, the vehicle accelerates. The adaptive cruise control is deactivated. When the driver no longer actuates the accelerator pedal, various actions may be provided: the adaptive cruise control is automatically reactivated, the adaptive cruise control remains deactivated, or the driver must manually reactivate the adaptive cruise control.

In particular, if multiple driver assistance systems are installed in one vehicle, the driver assistance systems may influence one another, which may lead to problems in some cases.

### BRIEF SUMMARY OF THE INVENTION

The object underlying the present invention may be therefore seen in that a device and a method for operating a driver assistance system are to be provided for a vehicle which allow for a safe vehicle operation.

The object underlying the present invention may also be seen as providing a corresponding database system as well as a corresponding computer program.

According to one aspect, a device for operating a driver assistance system for a vehicle is provided. The device includes a control unit which may control an operating state of the driver assistance system. In this case, the control unit is in particular designed to control the operating state as a function of another operating state of another driver assistance system for a vehicle.

According to another aspect, a method for operating a driver assistance system for a vehicle is provided. Here, an operating state of the driver assistance system is controlled as a function of another operating state of another driver assistance system for a vehicle.

According to yet another aspect, a database system is provided which includes a database in which a reference table is stored. The reference table includes in particular the information regarding which driver assistance systems may be activated at the same time.

According to yet another aspect, a computer program is provided which includes program code for carrying out the method for operating a driver assistance system for a vehicle when the computer program is run on a control unit.

Thus, the present invention includes the idea of controlling the operating state of a driver assistance system in particular as a function of another operating state of another driver assistance system. This means, in particular, that the other operating state of the other driver assistance system preferably has an influence on the operating state of the driver assistance system. Thus, a mutual disadvantageous influence of the driver assistance systems is advantageously avoided. In particular, contradicting actions of the driver assistance systems are thus advantageously not possible. In this way, vehicle safety is furthermore advantageously considerably increased.

An operating state in the sense of the present invention may preferably be an active or activated operating state or a deactivated operating state. In an active operating state, the driver assistance system makes available its corresponding driver assistance system function. In an active operating state, an adaptive cruise control (ACC), for example, brakes or accelerates the vehicle according to a set setpoint speed and/or a distance between the vehicle and a vehicle traveling ahead of the vehicle.

An active operating state may in particular also mean that the driver assistance system is in a preparation mode in which the driver assistance system function is not yet made available, but in which the corresponding preparations are carried out in order to make available the corresponding driver assistance system function.

A driver assistance system which is in an active operating state may preferably also be referred to as an active or activated driver assistance system.

In a deactivated operating state, the driver assistance system does not make available its corresponding driver assistance system function at this particular moment. The adaptive cruise control does not brake or accelerate the vehicle at this particular moment according to the set setpoint speed and distance. A deactivated operating state may in particular mean that the driver assistance system is turned off. A deactivated operating state may in particular also mean that the driver assistance system is in a stand-by mode.

A driver assistance system which is in a deactivated operating state may preferably also be referred to as a deactivated driver assistance system.

According to one specific embodiment, the control unit is designed to deactivate, to activate the driver assistance system and/or to block an operating state change of the driver assistance system. This means in particular that the control unit is designed to deactivate an active driver assistance system. This means in particular that the control unit is designed to activate a deactivated driver assistance system. This therefore means in particular that the control unit keeps the driver assistance system in its present operating state and prevents possible operating state changes. An activated driver assistance system is thus kept in the active operating state. A deactivated driver assistance system is thus kept in the deactivated operating state.

According to another specific embodiment, a detection device for detecting the other operating state is provided. In this way, the other operating state of the other driver assistance system may be advantageously detected. It may preferably be provided that the other driver assistance system actively communicates its other operating state to the control unit.

In another specific embodiment, a database system is provided which includes a database which has a reference table. The reference table includes in particular the information regarding which driver assistance systems may be activated at the same time. Depending on the reference table and depending on the other operating state, it may then in particular be provided that the control unit controls the operating state of the driver assistance system. If, for example, the other driver assistance system is activated and the reference table indicates that in this case, if the other driver assistance system is activated the driver assistance system itself may not be activated, the driver assistance system is kept deactivated or is deactivated. If, for example, the reference table provides the information that, even if the other driver assistance system is activated the driver assistance system may be operated simultaneously with the other driver assistance system, the control unit may activate the driver assistance system or keep it in the activated operating state.

According to one specific embodiment, the database system includes a control signal generator which is configured to generate control signals. These control signals are in particular used for controlling the operating state of the driver assistance system. The generation of the corresponding control signals is based in particular on the reference table and on the state data which correspond to a detected other operating state of the other driver assistance system. This means in particular that the state data may for example be sent to the database system. The control signals are then in particular sent to the control unit. The control unit may then control the operating state of the driver assistance system as a function of the control signals.

According to one specific embodiment, it may be provided that the database system is situated externally from the vehicle. “Externally” refers in this case to an area outside of the vehicle, in particular. In this case, the database system may also be referred to as an external database system. An external database system in particular has the advantage that other vehicles having corresponding devices for operating a driver assistance system may access the database.

According to another specific embodiment, it may be provided that the database system is situated in the vehicle. Here, the database system may be referred to as an internal database system. The provision of an internal database system has in particular the advantage that a communication between the control unit and the database may be carried out particularly simply and reliably.

According to one specific embodiment, a communication between the device and a database system, in particular an external database system, may be carried out with the aid of wireless communication processes. This may include a WLAN communication process, for example. In particular, a cellular radio communication process may be provided. A cellular radio communication process may include the “long-term evolution” (LTE) communication process, for example. A communication between the device and the external database system may be carried out via the C2I communication process, for example. Here, the abbreviation “C2I” stands for “car-to-infrastructure.” Such a communication process refers to a communication between a vehicle and a stationary infrastructure, such as an external server or a signal system.

The communication between the device and the database system may preferably be encrypted.

According to one specific embodiment, the database system may include multiple databases, at least one database being situated in the vehicle and another database being situated externally from the vehicle. It may in particular be provided that multiple databases are queried, these databases being situated internally and externally in relation to the vehicle, in order to ascertain whether the driver assistance system is to be activated or deactivated if the other driver assistance system is activated or deactivated. A corresponding communication between the databases may in particular be carried out with the aid of the previously mentioned communication processes. Thus, a redundancy may be advantageously provided so that a control of the operating state of the driver assistance system is possible even in the case of failure of one database or in the case of failure of one communication channel.

According to one specific embodiment, a communication interface may be provided with the aid of which the device communicates with an external database or an external database system. This may be a communication interface, for example, which is fixedly situated in the vehicle, e.g., a so-called “head unit,” i.e., a central control server of the vehicle. It may also be provided that the communication interface is a cellular radio device, e.g., a smart phone. The cellular radio device may communicate with the vehicle, i.e., with the central control server, in particular via wireless communication processes such as WLAN or Bluetooth.

In particular, when an internal database system or an internal database is provided, it may be provided that the database may be manually updated by the driver. For example, the corresponding data may be updated with the aid of a data carrier. The data may, for example, be obtained via an external computer of an external database system.

According to one specific embodiment, the other driver assistance system is designed to make available an at least semi-autonomous driving function. It may preferably be provided that the other driver assistance system makes available an autonomous driving function. Preferably, the driver assistance system is deactivated or kept in a deactivated state if the other driver assistance system is activated. Such an autonomous or semi-autonomous driving function may, for example, be a driving function which takes over the vehicle operation from the driver for a certain time interval, e.g., a few seconds, in particular 10 seconds. This means, in particular, that the driver does not operate or control the vehicle him/herself during this time interval. The vehicle is controlled in this case with the aid of the corresponding driver assistance system. In particular, if an autonomous driver assistance system or a semi-autonomous driver assistance system is therefore activated or intends to carry out an action, other driver assistance systems may not be activated. This in particular means that activated driver assistance systems are deactivated or a deactivated driver assistance system is kept in its deactivated state. Such driver assistance systems, which may not be activated when an autonomous or semi-autonomous driver assistance system is activated, may, for example, include an adaptive cruise control (ACC), a lane keeping assistant, a lane changing assistant, a tracking assistant, an evasion assistant, or an emergency braking assistant.

According to one specific embodiment, a plurality of driver assistance systems may also be provided, a particular operating state being controlled with the aid of the control unit as a function of the other operating state of the other driver assistance system. The above-described embodiments are applicable analogously to the plurality of driver assistance systems.

In another specific embodiment, multiple other driver assistance systems may be provided, the operating state of the driver assistance system being controlled as a function of the at least one operating state of the particular operating states of the multiple other driver assistance systems. The above-described embodiments are applicable analogously to the multiple other driver assistance systems.

### BRIEF DESCRIPTION OF THE DRAWINGS

FIG. 1 shows a device for operating a driver assistance system for a vehicle.

FIG. 2 shows a vehicle.

FIG. 3 shows a flow chart of a method for operating a driver assistance system for a vehicle.

FIG. 4 shows a database system.

FIG. 5 shows the vehicle according to FIG. 2 and the database system according to FIG. 4.

### DETAILED DESCRIPTION OF THE INVENTION

The same reference numerals are used below for the same features.

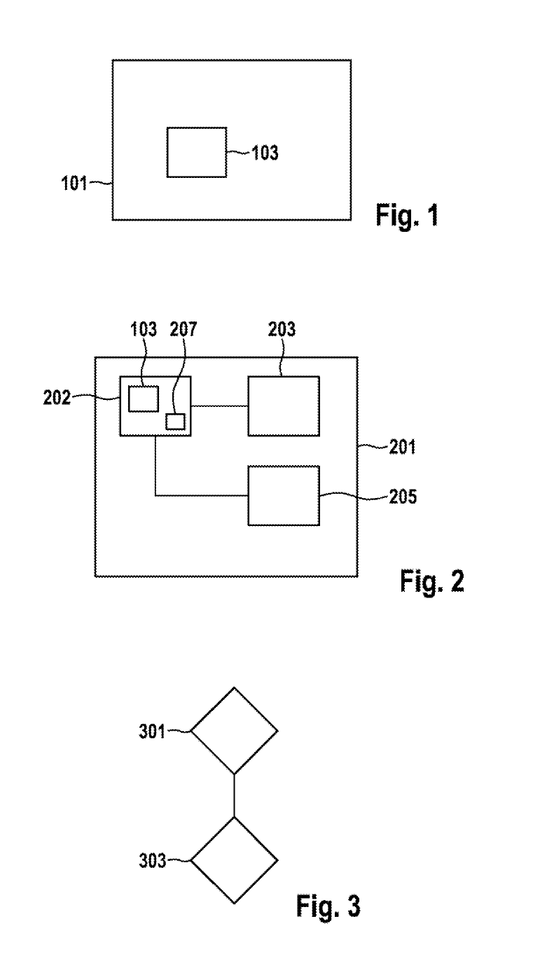

FIG. 1 shows a device 101 for operating a driver assistance system (not illustrated) for a vehicle (not illustrated). Device 101 includes a control unit 103 which is designed to control an operating state of the driver assistance system. In this case, control unit 103 is in particular designed to control the operating state as a function of another operating state of another driver assistance system for the vehicle.

FIG. 2 shows a vehicle 201 including a device 202 for operating a driver assistance system for vehicle 201. Here, vehicle 201 includes a driver assistance system 203 and another driver assistance system 205. Device 202 has an essentially similar design to that of device 101 according to FIG. 1. In addition, device 202 also has a detection device 207 for detecting the other operating state of other driver assistance system 205.

Device 202 thus detects the other operating state of other driver assistance system 205 with the aid of detection device 207. As a function thereof, control unit 103 controls the operating state of driver assistance system 203.

In one specific embodiment, which is not illustrated, it may be provided that vehicle 201 has even more other driver assistance systems. In particular, it may be provided that detection device 207 may detect the corresponding operating states of these multiple other driver assistance systems. Driver assistance system 203 may then be controlled, in particular, as a function of the detected corresponding multiple other operating states. In particular, it may generally be provided that detection device 207 may also detect the operating state of driver assistance system 203. In this way, it is advantageously possible that the driver assistance systems which are installed in a vehicle cannot have a disadvantageous effect on one another and cannot interfere with one another. A safe vehicle operation is thus advantageously made possible.

FIG. 3 shows a flow chart of a method for operating a driver assistance system for a vehicle. In a step 301, another operating state of another driver assistance system for the vehicle is detected. In a step 303, the operating state of the driver assistance system is controlled as a function of the detected other operating state. For example, it may be provided that when the other driver assistance system is activated, the driver assistance system is deactivated or kept in a deactivated operating state.

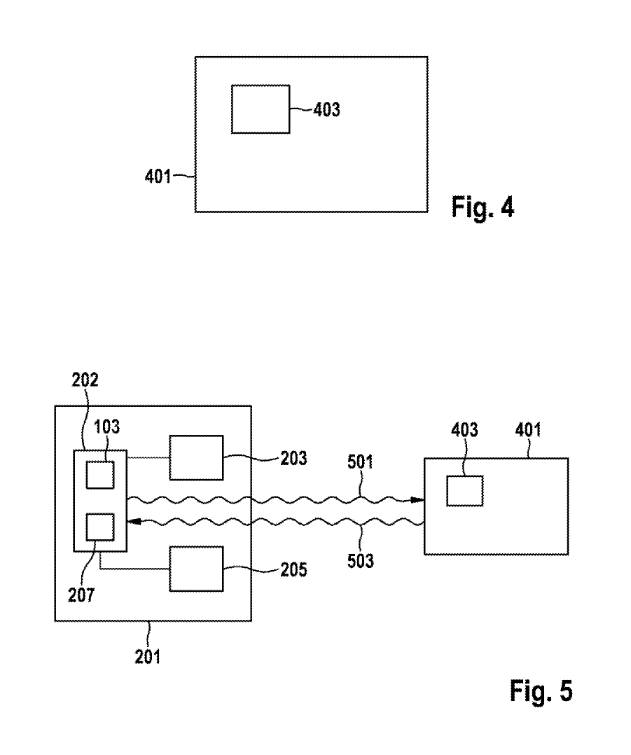

FIG. 4 shows a database system 401, which includes a database 403. A reference table, which in particular includes the information as to which driver assistance systems may be activated simultaneously, is stored in database 403.

FIG. 5 shows vehicle 201 according to FIG. 2 and database system 401 according to FIG. 4. According to FIG. 5, it is shown how device 202 sends state data, which correspond to the detected other operating state of other driver assistance system 205, to database system 401. This sending is illustrated here symbolically with the aid of a wavy arrow having reference numeral 501. Device 202 therefore poses in particular a corresponding request to database system 401 to accordingly query database 403. A response to the corresponding request is sent to device 202 by database system 401. This sending is illustrated here symbolically with the aid of a wavy arrow having reference numeral 503. The response of database system 401 includes here in particular information as to whether driver assistance system 203 is to be activated or deactivated. The information is generated here in particular as a function of the detected other operating state of other driver assistance system 205 and as a function of the reference table. In particular, it may be provided that database system 401 sends control signals, corresponding to the information, to control unit 103.

In the exemplary embodiment shown in FIG. 5, database system 401 is situated externally from vehicle 201. This has the advantage in particular that other vehicles, which are not shown here, may send corresponding requests to database system 401. In particular, such an external database system 401 may be updated particularly easily.

In one exemplary embodiment, which is not illustrated, it may be provided that database system 401 is situated internally in vehicle 201. Here, database 403 may be updated particularly advantageously with the aid of a data carrier.

In another specific embodiment, which is not shown, it may be provided that, in addition to the reference table, other functions which are made available by cellular radio devices, in particular smart phones, are integrated into database 403.

In another specific embodiment, which is not shown, it may be provided that other driver assistance system 205 is a driver assistance system which makes available an autonomous or a semi-autonomous driving function. Such an autonomous or semi-autonomous driving function may, for example, be a driving function which takes over the vehicle operation from the driver for a certain time interval, e.g., a few seconds, in particular 10 seconds. This means, in particular, that the driver does not operate or control the vehicle him/herself during this time interval. The vehicle is controlled in this case with the aid of driver assistance system 205. Driver assistance system 203 may, for example, be an ACC, a lane keeping assistant, a lane changing assistant, a tracking assistant, an evasion assistant, or an emergency braking assistant.

The present invention thus includes, in particular, the concept that a driver assistance system is deactivated or not even activated when an autonomous or a semi-autonomous driver assistance system is activated or will be activated, i.e., if a corresponding action is intended. Thus, an interference or a mutual negative influence of the driver assistance systems may advantageously be avoided.

1-13. (canceled)

14. A device for operating a selected driver assistance system among a plurality of driver assistance systems for a vehicle, comprising:
a control unit for controlling an operating state of the selected driver assistance system;
wherein the control unit is configured to control the operating state of the selected driver assistance system as a function of an operating state of a second driver assistance system for the vehicle.

15. The device as recited in claim 14, wherein the control unit is configured to at least one of selectively activate the selected driver assistance system, selectively deactivate the selected driver assistance system, and selectively block an operating state change of the selected driver assistance system.

16. The device as recited in claim 15, further comprising:
a detection device for detecting the operating state of the second driver assistance system.

17. The device as recited in claim 16, further comprising:
a database system including a database which stores a reference table containing information regarding which driver assistance systems among the plurality of driver assistance systems are permitted to be activated simultaneously.

18. The device as recited in claim 17, wherein the database system includes a control signal generator for generating control signals for the control unit based on the reference table and state data which correspond to the detected operating state of the second driver assistance system.

19. A method for operating a selected first driver assistance system among a plurality of driver assistance systems for a vehicle, comprising:
detecting an operating state of a second driver assistance system for the vehicle; and
controlling, by a control unit, an operating state of the selected first driver assistance system as a function of the operating state of the second driver assistance system for the vehicle.

20. The method as recited in claim 19, wherein controlling the operating state includes at least one of selectively activating the selected first driver assistance system, selectively deactivating the selected first driver assistance system, and selectively blocking an operating state change of the selected first driver assistance system.

21. The method as recited in claim 20, wherein state data corresponding to the operating state of the second driver assistance system are sent to a database system including a database which stores a reference table containing information regarding which driver assistance systems among the plurality of driver assistance systems are permitted to be activated simultaneously.

22. The method as recited in claim 21, wherein control signals are generated in the database system as a function of the state data and the reference table, and wherein the control signals are sent to a control unit for controlling the operating state of the selected first driver assistance system.

23. The method as recited in claim 20, wherein the second driver assistance system is configured to make available an at least semi-autonomous driving function, and the selected first driver assistance system is one of deactivated or kept in a deactivated operating state if the second driver assistance system is activated.

24. A non-transitory computer-readable data storage medium storing a computer program having program codes which, when executed on a computer, performs a method for operating a selected first driver assistance system among a plurality of driver assistance systems for a vehicle, the method comprising:
detecting an operating state of a second driver assistance system for the vehicle; and
controlling, by a control unit, an operating state of the selected first driver assistance system as a function of the operating state of the second driver assistance system for the vehicle.
